(19) United States
(12) Patent Application Publication
(10) Pub. No.: US 2012/0025763 A1
(43) Pub. Date: Feb. 2, 2012

(54) CHARGING SYSTEM OF MOBILE VEHICLE AND METHOD FOR OPERATING THE SAME

(76) Inventors: Ko-Yu Hsiao, Taoyuan Shien (TW); Chang-Jyi Sheu, Taoyuan Shien (TW); Tse-Hua Chi, Taoyuan Shien (TW)

(21) Appl. No.: 13/105,418

(22) Filed: May 11, 2011

(30) Foreign Application Priority Data
Jul. 30, 2010 (TW) 099125281

(51) Int. Cl. H02J 7/04

(52) U.S. Cl. 320/109

(57) ABSTRACT

A charging system of a mobile vehicle and a method for operating the same are provided to receive and convert an external AC source into a DC source for charging the mobile vehicle. First, a high DC voltage is outputted through a charging apparatus. Afterward, the high DC voltage is received and converted by a DC power conversion apparatus in the mobile vehicle, thus the required voltage level of the high DC voltage is provided for a rechargeable battery. Finally, the DC power conversion apparatus is controlled through a vehicle controller to provide the desired charging current for the rechargeable battery. The DC power conversion apparatus is installed in the mobile vehicle so that the rechargeable battery is protected by the DC power conversion apparatus. In addition, an adaptive charging manner is provided according to operating conditions of the rechargeable battery, thus increasing charging reliability, security, and speed.

### BACKGROUND OF THE INVENTION

1. Field of the Invention

The present invention relates to a charging system of a mobile vehicle and a method for operating the same, and more particularly to a charging system of a mobile vehicle, which installing a DC power conversion apparatus, and a method for operating the same.

2. Description of Prior Art

For today's technologies of driving mobile vehicles, that will be developed toward the trend of pollution-free and high-efficiency purposes. The battery is usually used to store the desired energy for the electric vehicles. In particular, the various generated energies, such as coal-fire energy, hydraulic energy, wind energy, thermal energy, solar energy, and nuclear energy, have to be converted into the electrical energy so that the electrical energy can be stored in the battery. However, the major issues of security, efficiency, and convenience have to be concerned during the energy conversion process.

Reference is made to FIG. 1 which is a block diagram of a prior art charging system of a mobile vehicle. The charging system of the mobile vehicle (not shown) mainly includes a charging apparatus 10A and a rechargeable battery 20A. The mobile vehicle can be an electric vehicle, and the rechargeable battery 20A is a rechargeable battery for electric vehicles.

The charging apparatus 10A includes an electromagnetic interference (EMI) filter 102A, a power factor corrector 104A, and a non-isolated DC/DC converter 106A.

The EMI filter 102A of the charging apparatus 10A is electrically connected to an external AC source Vs to eliminate the noise in the AC source Vs, thus preventing the conductive electromagnetic interference. The power factor corrector 104A is electrically connected to the EMI filter 102A to improve the power factor of the converted DC source. The non-isolated DC/DC converter 106A is electrically connected to the power factor corrector 104A to provide required voltage levels. In particular, the non-isolated DC/DC converter 106A can be a buck converter or a DC transformer.

In actual application, the charging apparatus 10A is a charging station for electric vehicles.

The charging apparatus 10A can provide a high DC voltage Vo that outputs a fixed power. The charging apparatus 10A typically outputs a 500-volt DC voltage that provides a 50-Kw or 30-kW power. If the power of the rechargeable battery 20A is insufficient, the rechargeable battery 20A is charged by directly connecting the charging apparatus 10A to the rechargeable battery 20A. In this charging system, however, the required charging current can not be provided to the rechargeable battery 20A because operating conditions (such as the capacity, voltage, or temperature) of the rechargeable battery are not detected. Thus, the lifetime of the rechargeable battery 20A would reduce. Furthermore, the charging reliability of the rechargeable battery 20A would reduce because this charging system can not provide an adaptive charging manner for the rechargeable battery 20A. In addition, the prior art charging system of the mobile vehicle usually uses mechanical-type relay for protecting the rechargeable battery 20A. That is, the mechanical-type relay could provide a trip protection for the rechargeable battery 20A during the charging process when the charging system has an abnormal operation. However, the response time of the mechanical-type relay is usually slow. Hence, the time of receiving an external trip signal and accomplishing the trip operation through the mechanical-type relay is usually long enough to damage the rechargeable battery 20A when the abnormal operation occurs.

Accordingly, it is desirable to provide a charging system of a mobile vehicle and a method for operating the same that provide a charging protection and an adaptive charging manner for the rechargeable battery according to operating conditions of the rechargeable battery, thus increasing charging reliability, security, and speed.

### SUMMARY OF THE INVENTION

In order to solve the above-mentioned problems, a charging system of a mobile vehicle is disclosed. The charging system of the mobile vehicle receives and converts an external AC source into a DC source for charging a rechargeable battery of the mobile vehicle. The charging system includes a charging apparatus and a mobile vehicle.

The charging apparatus includes an EMI filter and a power factor corrector. The EMI filter receives the external AC source. The power factor corrector is electrically connected to the EMI filter to output a high DC voltage.

The charging apparatus further includes a DC power conversion apparatus installed in the mobile vehicle and a vehicle controller installed in the mobile vehicle. The DC power conversion apparatus is installed in the mobile vehicle and is electrically connected to the charging apparatus to receive the high DC voltage and converts a voltage level of the high DC voltage into a required voltage level for the rechargeable battery. The vehicle controller is installed in the mobile vehicle and is electrically connected to the DC power conversion apparatus to control the DC power conversion apparatus to provide the required charging current for the rechargeable battery.

Therefore, the DC power conversion apparatus is installed in the mobile vehicle to provide charging protection for the rechargeable battery, and an adaptive charging manner is provided according to operating conditions of the rechargeable battery, thus increasing charging reliability, security, and speed.

In order to solve the above-mentioned problems, a charging method for a charging system of a mobile vehicle, the charging system receives and converts an external AC source into a DC source for charging a rechargeable battery of a mobile vehicle. The steps of the charging method as follows: First, a high DC voltage is provided through a charging apparatus. Afterward, the high DC voltage is received and a voltage level of the high DC voltage is converted into a required voltage level for the rechargeable battery through a DC power conversion apparatus. Finally, the required charging current for the rechargeable battery is provided according to the DC power conversion apparatus controlled by a vehicle controller.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a block diagram of a prior art charging system of a mobile vehicle;

FIG. 2 is a block diagram of a charging system of a mobile vehicle according to a first embodiment of the present invention;

FIG. 3 is a block diagram of a charging system of a mobile vehicle according to a second embodiment of the present invention;

FIG. 4 is a block diagram of a charging system of a mobile vehicle according to a third embodiment;

FIG. 5 is a block diagram of a charging system of a mobile vehicle according to a fourth embodiment;

FIG. 6 is a block diagram of a charging system of a mobile vehicle according to a fifth embodiment; and

FIG. 7 is a flowchart of a charging method for a charging system of a mobile vehicle.

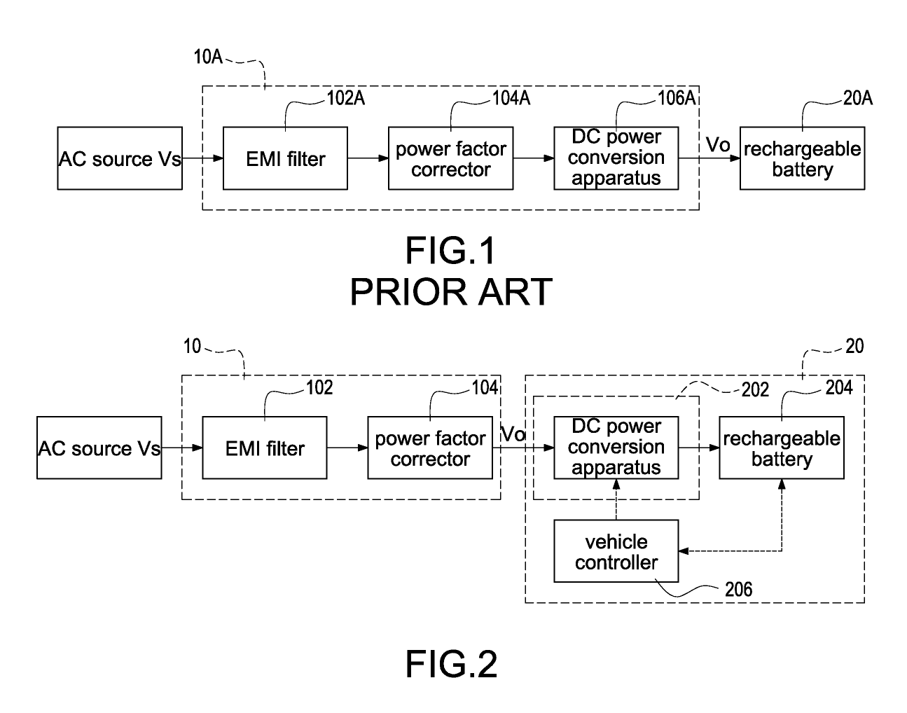

### DETAILED DESCRIPTION OF THE INVENTION

Reference will now be made to the drawing figures to describe the present invention in detail.

Reference is made to FIG. 2 which is a block diagram of a charging system of a mobile vehicle according to a first embodiment of the present invention. The charging system of the mobile vehicle receives and converts an external AC source into a DC source for charging a rechargeable battery of the mobile vehicle. The charging system of the mobile vehicle includes a charging apparatus 10 and a mobile vehicle 20. In particular, the mobile vehicle 20 can be an electric vehicle.

The charging apparatus 10 mainly includes an EMI filter 102 and a power factor corrector 104. The EMI filter 102 receives the external AC source Vs to eliminate the noise in the AC source Vs, thus preventing the conductive electromagnetic interference. The power factor corrector 104 is electrically connected to the EMI filter 102 to output a high DC voltage Vo.

The mobile vehicle 20 mainly includes a DC power conversion apparatus 202, a rechargeable battery 204, and a vehicle controller 206. In this embodiment, the DC power conversion apparatus 202 is a non-isolated DC/DC converter 202, and the non-isolated DC/DC converter 202 can be a buck converter or a DC transformer. The DC power conversion apparatus 202 is electrically connected to the charging apparatus 10 to receive the high DC voltage Vo and converts a voltage level of the high DC voltage Vo into a required voltage level for the rechargeable battery 204. The rechargeable battery 204 is electrically connected to the DC power conversion apparatus 202. In particular, the rechargeable battery 204 is a rechargeable battery for electric vehicles. The vehicle controller 206 is electrically connected to the DC power conversion apparatus 202 and the rechargeable battery 204 to control the DC power conversion apparatus 202 to provide the required charging current for the rechargeable battery 204. Compared with the prior art, the non-isolated DC/DC converter 202 is changed from the charging apparatus 10 to the mobile vehicle 20.

In actual application, the charging apparatus 10 is a charging station for electric vehicles. The charging apparatus 10 can provide the high DC voltage Vo that outputs a fixed power. The charging apparatus 10 typically outputs a 500-volt DC voltage that provides a 50-kW or 30-kW power. If the power of the rechargeable battery 204 is insufficient, the rechargeable battery 204 is charged by connecting the charging apparatus 10 to the DC power conversion apparatus 202 and then connecting the DC power conversion apparatus 202 to the rechargeable battery 204. Hence, the vehicle controller 206 controls the DC power conversion apparatus 202 to provide the required charging current for the rechargeable battery 204 according to the capacity of the rechargeable battery 204. Simultaneously, the corresponding charging time can be calculated. For example, if the rechargeable battery 204 is a high-capacity rechargeable battery, the vehicle controller 206 controls the DC power conversion apparatus 202 to provide a higher output charging current to the rechargeable battery 204. Whereas, if the rechargeable battery 204 is a low-capacity rechargeable battery, the vehicle controller 206 controls the DC power conversion apparatus 202 to provide a lower outputted charging current to the rechargeable battery 204. In addition, the vehicle controller 206 controls the DC power conversion apparatus 202 to provide the required charging current for the rechargeable battery 204 according to the voltage of the rechargeable battery 204. Simultaneously, the corresponding charging time can be calculated. When the rechargeable battery 204 is charged to the desirable voltage, the vehicle controller 206 controls the DC power conversion apparatus 202 to reduce the required charging current for the rechargeable battery 204. For example, if the rechargeable battery 204 is a high-capacity rechargeable battery (which needs a higher voltage), the vehicle controller 206 controls the DC power conversion apparatus 202 to provide a higher output charging current to the rechargeable battery 204. However, if the rechargeable battery 204 is a low-capacity rechargeable battery (which needs a lower voltage), the vehicle controller 206 controls the DC power conversion apparatus 202 to provide a lower outputted charging current to the rechargeable battery 204. In addition, the vehicle controller 206 controls the DC power conversion apparatus 202 to provide the required charging current for the rechargeable battery 204 according to the capacity and temperature of the rechargeable battery 204. Simultaneously, the corresponding charging time can be calculated. For example, if the rechargeable battery 204 is operated in a higher-temperature condition, the vehicle controller 206 controls the DC power conversion apparatus 202 to provide a lower outputted charging current to the rechargeable battery 204. However, if the rechargeable battery 204 is operated in a lower-temperature condition, the vehicle controller 206 controls the DC power conversion apparatus 202 to provide a higher output charging current to the rechargeable battery 204.

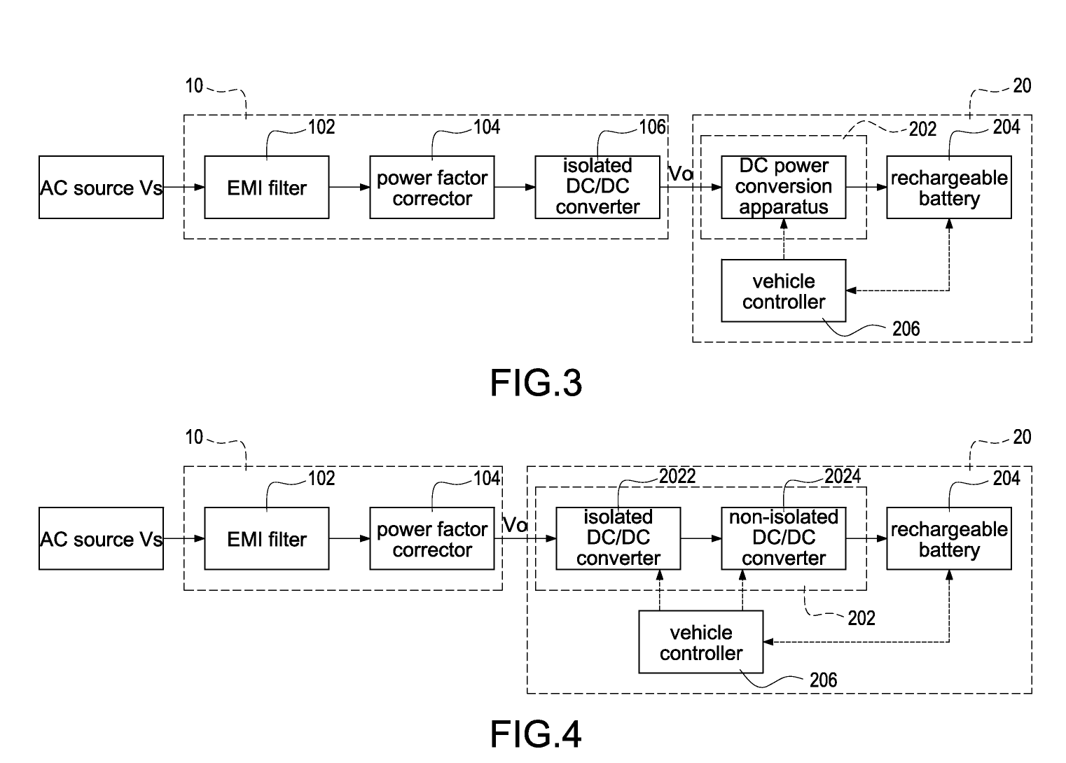

Reference is made to FIG. 3 which is a block diagram of a charging system of a mobile vehicle according to a second embodiment of the present invention. In this embodiment, the operation manners of the charging apparatus 10 and the mobile vehicle 20 are similar to those of the first embodiment. The major difference, however, is that the charging apparatus 10 further includes an isolated DC/DC converter 106. The isolated DC/DC converter 106 is electrically connected to the power factor corrector 104 to output the high DC voltage Vo.

Reference is made to FIG. 4 which is a block diagram of a charging system of a mobile vehicle according to a third embodiment of the present invention. In this embodiment, the operation manners of the charging apparatus 10 and the mobile vehicle 20 are similar to those of the first embodiment. The major difference, however, is that the DC power conversion apparatus 202 of the mobile vehicle 20 further includes an isolated DC/DC converter 2022. The isolated DC/DC converter 2022 is electrically connected to the non-isolated DC/DC converter 2024 to receive the high DC voltage Vo outputted from the charging apparatus 10.

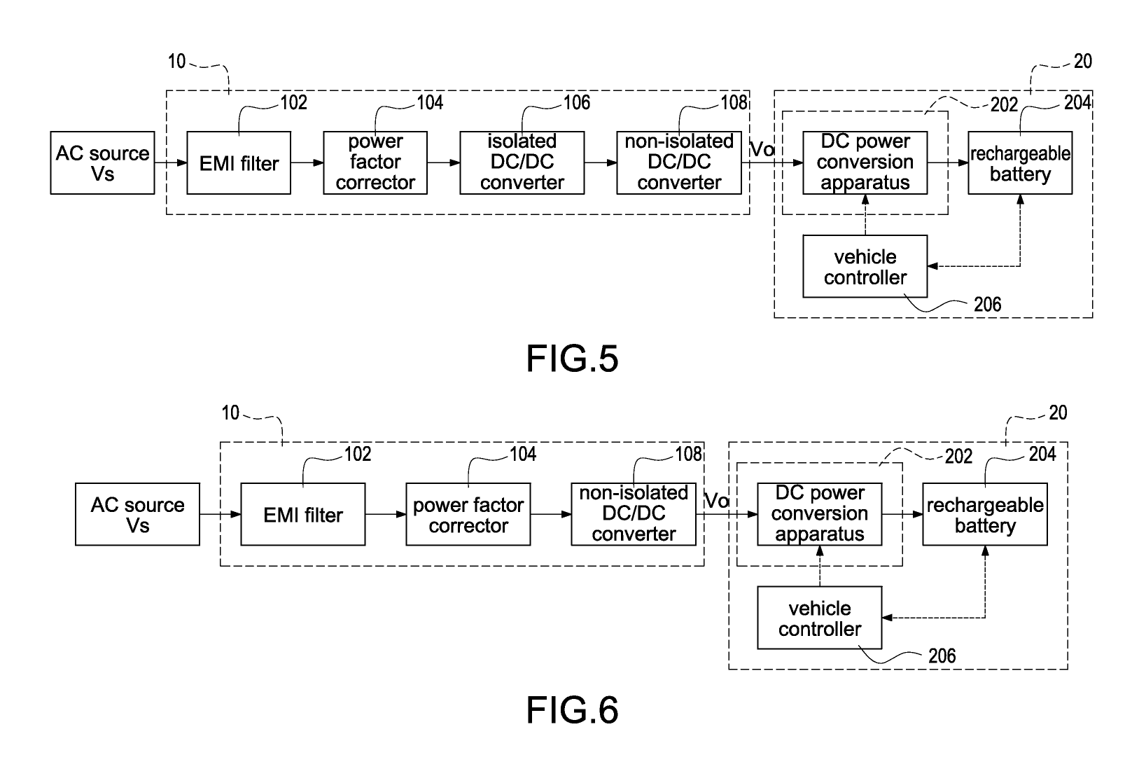

Reference is made to FIG. 5 which is a block diagram of a charging system of a mobile vehicle according to a fourth embodiment of the present invention. In this embodiment, the operation manners of the charging apparatus 10 and the mobile vehicle 20 are similar to those of the first embodiment. The major difference, however, is that the charging apparatus 10 further includes an isolated DC/DC converter 106 and a non-isolated DC/DC converter 108. The isolated DC/DC converter 106 is electrically connected to the power factor corrector 104, and the non-isolated DC/DC converter 108 is electrically connected to the isolated DC/DC converter 106 to output the high DC voltage Vo. In particular, the non-isolated DC/DC converter 108 can be a buck converter or a DC transformer.

Reference is made to FIG. 6 which is a block diagram of a charging system of a mobile vehicle according to a fifth embodiment of the present invention. In this embodiment, the operation manners of the charging apparatus 10 and the mobile vehicle 20 are similar to those of the first embodiment. The major difference, however, is that the charging apparatus 10 further includes a non-isolated DC/DC converter 108. The non-isolated DC/DC converter 108 is electrically connected to the power factor corrector 104 to output the high DC voltage Vo.

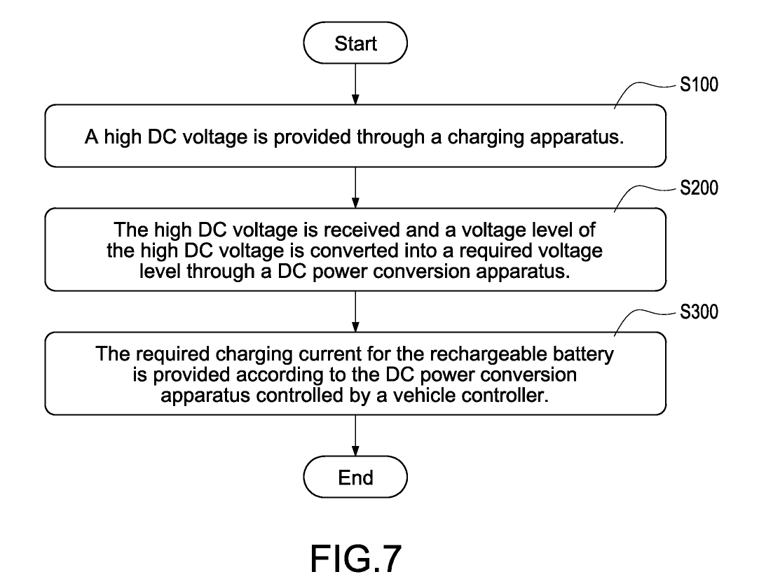

Reference is made to FIG. 7 which is a flowchart of a charging method for a charging system of a mobile vehicle. Although the charging apparatus and the DC power conversion apparatus have different embodiments, the charging manner of the mobile vehicle is identical. The charging method is provided to receive and convert an external AC source into a DC source, and then the DC source is used to charge the mobile vehicle. The steps of the charging method as follows: First, a high DC voltage is provided through a charging apparatus (S100). In particular, the charging apparatus includes an EMI filter and a power factor corrector. The power factor corrector is electrically connected to the EMI filter to output the high DC voltage. The charging apparatus includes an EMI filter, a power factor corrector, and an isolated DC/DC converter. The power factor corrector is electrically connected to the EMI filter, and the isolated DC/DC converter is electrically connected to the power factor corrector to output the high DC voltage. Furthermore, the charging apparatus includes an EMI filter, a power factor corrector, and a non-isolated DC/DC converter. The power factor corrector is electrically connected to the EMI filter, and the non-isolated DC/DC converter is electrically connected to the power factor corrector to output the high DC voltage. Furthermore, the charging apparatus includes an EMI filter, a power factor corrector, an isolated DC/DC converter, and a non-isolated DC/DC converter. The power factor corrector is electrically connected to the EMI filter, the isolated DC/DC converter is electrically connected to the power factor corrector, and the non-isolated DC/DC converter is electrically connected to the isolated DC/DC converter to output the high DC voltage.

Afterward, the high DC voltage is received and a voltage level of the high DC voltage is converted into a required voltage level for the rechargeable battery through a DC power conversion apparatus (S200). In particular, the DC power conversion apparatus is a non-isolated DC/DC converter to receive the high DC voltage outputted from the charging apparatus. Furthermore, the DC power conversion apparatus includes an isolated DC/DC converter and a non-isolated DC/DC converter. The isolated DC/DC converter is electrically connected to the non-isolated DC/DC converter to receive the high DC voltage outputted from the charging apparatus.

Finally, the required charging current for the rechargeable battery is provided according to the DC power conversion apparatus controlled by a vehicle controller (S300). If the power of the vehicle rechargeable battery is insufficient, the rechargeable battery is charged by connecting the charging apparatus to the DC power conversion apparatus and then connecting the DC power conversion apparatus to the rechargeable battery. Hence, the vehicle controller controls the DC power conversion apparatus to provide the required charging current for the rechargeable battery according to the capacity of the rechargeable battery. Simultaneously, the corresponding charging time can be calculated. For example, if the rechargeable battery is a high-capacity rechargeable battery, the vehicle controller controls the DC power conversion apparatus to provide a higher output charging current to the rechargeable battery. However, if the rechargeable battery is a low-capacity rechargeable battery, the vehicle controller controls the DC power conversion apparatus to provide a lower outputted charging current to the rechargeable battery. In addition, the vehicle controller controls the DC power conversion apparatus to provide the required charging current for the rechargeable battery according to the voltage of the rechargeable battery. Simultaneously, the corresponding charging time can be calculated. When the rechargeable battery is charged to the desirable voltage, the vehicle controller controls the DC power conversion apparatus to reduce the required charging current for the rechargeable battery. For example, if the rechargeable battery is a high-capacity rechargeable battery (which needs a higher voltage), the vehicle controller controls the DC power conversion apparatus to provide a higher output charging current to the rechargeable battery. However, if the rechargeable battery is a low-capacity rechargeable battery (which needs a lower voltage), the vehicle controller controls the DC power conversion apparatus to provide a lower outputted charging current to the rechargeable battery. In addition, the vehicle controller controls the DC power conversion apparatus to provide the required charging current for the rechargeable battery according to the capacity and temperature of the rechargeable battery. Simultaneously, the corresponding charging time can be calculated. For example, if the rechargeable battery is operated in a higher-temperature condition, the vehicle controller controls the DC power conversion apparatus to provide a lower outputted charging current to the rechargeable battery. Whereas, if the rechargeable battery is operated in a lower-temperature condition, the vehicle controller controls the DC power conversion apparatus to provide a higher output charging current to the rechargeable battery.

In conclusion, the present invention has following advantages:

1. The DC power conversion apparatus, which is installed in the mobile vehicle, is used to provide charging protection; and

2. An adaptive charging manner is provided according to operating conditions of the rechargeable battery, thus increasing charging reliability, security, and speed.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A charging system of a mobile vehicle receiving and converting an external AC source into a DC source for charging a rechargeable battery of the mobile vehicle; the charging system comprising:
a charging apparatus, comprising:
an electromagnetic interference (EMI) filter receiving the external AC source; and
a power factor corrector electrically connected to the EMI filter, and outputting a high DC voltage; and
a DC power conversion apparatus installed in the mobile vehicle and electrically connected to the charging apparatus, the DC power conversion apparatus receiving the high DC voltage and converting a voltage level of the high DC voltage into a required voltage level for the rechargeable battery; and
a vehicle controller installed in the mobile vehicle and electrically connected to the DC power conversion apparatus and the rechargeable battery, and controlling the DC power conversion apparatus to provide the required charging current for the rechargeable battery;
whereby the DC power conversion apparatus is installed in the mobile vehicle to provide charging protection for the rechargeable battery, and an adaptive charging manner is provided according to operating conditions of the rechargeable battery.

2. The charging system in claim 1, wherein the charging apparatus further comprises an isolated DC/DC converter, and the isolated DC/DC converter is electrically connected to the power factor corrector to output the high DC voltage.

3. The charging system in claim 1, wherein the charging apparatus further comprises a non-isolated DC/DC converter, and the non-isolated DC/DC converter is electrically connected to the power factor corrector to output the high DC voltage.

4. The charging system in claim 1, wherein the charging apparatus further comprises:
an isolated DC/DC converter electrically connected to the power factor corrector; and
a non-isolated DC/DC converter electrically connected to the isolated DC/DC converter to output the high DC voltage.

5. The charging system in claim 1, wherein the DC power conversion apparatus is a non-isolated DC/DC converter which receives the high DC voltage outputted from the charging apparatus.

6. The charging system in claim 1, wherein the DC power conversion apparatus comprises an isolated DC/DC converter and a non-isolated DC/DC converter, wherein the isolated DC/DC converter is electrically connected to the non-isolated DC/DC converter to receive the high DC voltage outputted from the charging apparatus.

7. The charging system in claim 1, wherein the vehicle controller controls the DC power conversion apparatus to provide the required charging current for the rechargeable battery according to the capacity of the rechargeable battery.

8. The charging system in claim 1, wherein the vehicle controller controls the DC power conversion apparatus to provide the required charging current for the rechargeable battery according to the voltage of the rechargeable battery.

9. The charging system in claim 1, wherein the vehicle controller controls the DC power conversion apparatus to provide the required charging current for the rechargeable battery according to the capacity and temperature of the rechargeable battery.

10. A charging method for a charging system of a mobile vehicle, the charging system receiving and converting an external AC source into a DC source for charging a rechargeable battery of a mobile vehicle; the steps of the charging method comprising:
(a) providing a high DC voltage through a charging apparatus;
(b) receiving the high DC voltage and converting a voltage level of the high DC voltage into a required voltage level for the rechargeable battery through a DC power conversion apparatus; and
(c) providing the required charging current for the rechargeable battery according to the DC power conversion apparatus controlled by a vehicle controller.

11. The charging method in claim 10, wherein the charging apparatus comprises an EMI filter and a power factor corrector, wherein the power factor corrector is electrically connected to the EMI filter to output the high DC voltage.

12. The charging method in claim 10, wherein the charging apparatus comprises an electromagnetic interference (EMI) filter, a power factor corrector, and an isolated DC/DC converter, wherein the power factor corrector is electrically connected to the EMI filter, and the isolated DC/DC converter is electrically connected to the power factor corrector to output the high DC voltage.

13. The charging method in claim 10, wherein the charging apparatus comprises an electromagnetic interference (EMI) filter, a power factor corrector, and a non-isolated DC/DC converter, wherein the power factor corrector is electrically connected to the EMI filter, and the non-isolated DC/DC converter is electrically connected to the power factor corrector to output the high DC voltage.

14. The charging method in claim 10, wherein the charging apparatus comprises an electromagnetic interference (EMI) filter, a power factor corrector, an isolated DC/DC converter, and a non-isolated DC/DC converter, wherein the power factor corrector is electrically connected to the EMI filter, the isolated DC/DC converter is electrically connected to the power factor corrector, and the non-isolated DC/DC converter is electrically connected to the isolated DC/DC converter to output the high DC voltage.

15. The charging method in claim 10, wherein the DC power conversion apparatus is a non-isolated DC/DC converter to receive the high DC voltage outputted from the charging apparatus.

16. The charging method in claim 10, wherein the DC power conversion apparatus comprises an isolated DC/DC converter and a non-isolated DC/DC converter, wherein the isolated DC/DC converter is electrically connected to the non-isolated DC/DC converter to receive the high DC voltage outputted from the charging apparatus.

17. The charging method in claim 10, in the step (c), wherein the vehicle controller controls the DC power conversion apparatus to provide the required charging current for the rechargeable battery according to the capacity of the rechargeable battery.

18. The charging method in claim 10, in the step (c), wherein the vehicle controller controls the DC power conversion apparatus to provide the required charging current for the rechargeable battery according to the voltage of the rechargeable battery.

19. The charging method in claim 10, in the step (c), wherein the vehicle controller controls the DC power conversion apparatus to provide the required charging current for the rechargeable battery according to the capacity and temperature of the rechargeable battery.
